(19) United States
(12) Patent Application Publication
(10) Pub. No.: US 2011/0201242 A1
(43) Pub. Date: Aug. 18, 2011

(54) Fiber for detecting target and use thereof

(75) Inventors: Jae-hyun Hur, Seongnam-si (KR); Jong-jin Park, Hwaseong-si (KR); Hyung-bin Son, Seoul (KR); Jae-do Nam, Suwon-si (KR)

(73) Assignee: Samsung Electronics Co., Ltd., Suwon-si (KR)

(21) Appl. No.: 12/805,931

(22) Filed: Aug. 25, 2010

(30) Foreign Application Priority Data
Feb. 17, 2010 (KR) 10-2010-0014251

(51) Int. Cl. B32B 5/00; C08B 3/06; C08F 216/06; C08F 20/10; G01N 31/22; G01N 27/00; D01D 5/00

(52) U.S. Cl. 442/181; 536/69; 525/56; 525/132; 428/373; 436/163; 436/149; 442/327; 264/172.11; 977/957

(57) ABSTRACT

Provided is a fiber for detecting a target, a method of preparing the fiber for detecting the target, a method of detecting the target in a sample, a fiber complex including the fiber for detecting the target, and a kit including the fiber for detecting the target. The fiber may include a polymer, a target detecting material, and a metal nanoparticle, wherein the target material and the metal nanoparticle are fixed to the polymer. The method of preparing a fiber may include preparing a composition that includes a polymer, a target detecting material, and a metal nanoparticle and spinning the composition to prepare the fiber.

### CROSS-REFERENCE TO RELATED APPLICATIONS

This application claims priority under 35 U.S.C. §119 to Korean Patent Application No. 10-2010-0014251, filed on Feb. 17, 2010, in the Korean Intellectual Property Office (KIPO), the entire contents of which are herein incorporated by reference.

### BACKGROUND

1. Field

Example embodiments relate to a fiber for detecting a target, a method of preparing the fiber for detecting the target, a method of detecting the target in a sample, a fiber complex including the fiber for detecting the target, and a kit including the fiber for detecting the target.

2. Description of the Related Art

Target detection includes detecting the existence of a target in a sample and detecting a target concentration in the sample. Target detection has been widely used in drug screening, disease diagnosis, environment pollution monitoring, and stability evaluation of food.

Conventional methods for detecting a target include electrophoresis, mass spectrometry, fluorescence analysis, and chromometry. In this regard, two-dimensional electrophoresis has relatively low reproducibility. If two-dimensional electrophoresis is used, particularly, for a biological sample, it is difficult to isolate alkaline proteins and high molecular weight proteins and achieve automated processing. Although unknown samples may be analyzed using mass spectrometry, it is difficult to quickly analyze a plurality of samples and minimize the mass spectrometry. Fluorescence analysis uses fluorescence generated by interactions between a medium detecting the target and the target, however, the range of targets that can be detected is limited. In addition, if a fluorescent material is labeled, the fluorescent material is required to be uniformly labeled. Additionally, fluorescent dyes are expensive.

A target may be simply detected using a chromometer. However, such a method takes a relatively long time and has relatively low sensitivity due to low interaction between a target and a target detecting medium.

### SUMMARY

Example embodiments provide a fiber for detecting a target, a method of preparing the fiber for detecting the target, a method of detecting the target in a sample, a fiber complex including the fiber for detecting the target, and a kit including the fiber for detecting the target.

In accordance with example embodiments, a fiber may include a polymer, a target detecting material, and a metal nanoparticle, wherein the target detecting material and the metal nanoparticle are fixed to the polymer.

In accordance with example embodiments, a method of preparing a fiber may include preparing a composition that includes a polymer, a target detecting material, and a metal nanoparticle and spinning the composition to prepare the fiber.

### BRIEF DESCRIPTION OF THE DRAWINGS

The patent or application file contains at least one drawing executed in color. Copies of this patent or patent application publication with color drawing will be provided by the Office upon request and payment of the necessary fee.

These and/or other aspects will become apparent and more readily appreciated from the following description of example embodiments, taken in conjunction with the accompanying drawings of which:

FIG. 1 schematically shows an island-in-the-sea fiber having a sea part including a polymer and an island part including target detecting materials and metal nanoparticles;

FIG. 2A schematically shows a core-shell fiber, and FIG. 2B schematically shows a color change of the core-shell fiber when the core-shell fiber reacts with a target;

FIG. 3 schematically shows an electrospinning device for preparing a fiber;

FIGS. 4A to 4D are scanning electron microscope (SEM) images of fibers prepared according to example embodiments, FIG. 4A is an SEM image of a fiber including 0.06 wt % of Au, FIG. 4B is an SEM image of a fiber including 0.09 wt % of Au, FIG. 4C is an SEM image of a fiber including 0.12 wt % of Au, and FIG. 4D is an SEM image of a fiber including 0.19 wt % of Au;

FIG. 5A shows color changes of fibers in contact with urine having various pH levels, according to example embodiments, and FIG. 5B shows color changes of filter paper platforms (Advantec Toyo Kaisha Ltd.) in contact with urine having various pH levels;

FIG. 6A shows color changes of fibers in contact with samples having various concentrations of blood, according to example embodiments, and FIG. 6B shows color changes of filter paper platforms (Advantec Toyo Kaisha Ltd.) which are in contact with samples having various concentrations of blood; and

FIG. 7A shows color changes of fibers in contact with ascorbic acid aqueous solutions having various concentrations, according to example embodiments, and FIG. 7B shows color changes of filter paper platforms (Advantec Toyo Kaisha Ltd.) in contact with ascorbic acid aqueous solutions having various concentrations.

### DETAILED DESCRIPTION

Example embodiments will now be described more fully with reference to the accompanying drawings. Embodiments, however, may be embodied in many different forms and should not be construed as being limited to the embodiments set forth herein. Rather, example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components that may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made in detail to example embodiments which are illustrated in the accompanying drawings, wherein like reference numerals refer to the like elements throughout. In this regard, example embodiments may have different forms and should not be construed as being limited to the descriptions set forth herein. Accordingly, example embodiments are merely described below, by referring to the figures, to explain aspects of the present description.

In accordance with example embodiments, a fiber may include a polymer, a target detecting material, and a metal nanoparticle, wherein the target material and the metal nanoparticle may be fixed to the polymer.

The term “polymer” used herein refers to a molecule capable of forming a matrix of a fiber. The polymer may be dissolved in a solvent and spun by known spinning methods to produce the fiber. Known spinning methods include, for example, electrospinning, wet spinning, conjugate spinning, melt blown spinning, and flash spinning.

The polymer may be a support forming a matrix of the fiber. The polymer may provide the fiber with structural stability, mechanical rigidity, and corrosion resistance. The polymer may have a relatively high affinity to the target detecting material or the metal nanoparticle or may form non-covalent bonds with the target material or the metal nanoparticle. The non-covalent bonds may include ionic bonds, hydrogen bonds, metallic bonds, van der Waals bonds, and hydrophobic interactions, but the bonds are not limited thereto. The polymer may function as a channel through which targets existing out of the fiber are diffused into the fiber. The polymer may be a material identifying detectable signals generated by interaction between the target detecting material and the target.

The polymer may be hydrophobic, hydrophilic, or amphiphilic. For example, the fiber may be hydrophilic. The polymer may be soluble or insoluble in organic solvents or aqueous solvents. For example, the fiber may be insoluble in aqueous solvents. For example, the polymer may be hydrophilic and insoluble in aqueous solvents.

The polymer may be a polymer insoluble in water or a material that may chemically form cross-linking by a treatment with a curing agent (for example, glyoxal), heat-treatment, or UV treatment. In example embodiments, the polymer may include a hydroxyl functional group.

The polymer may be selected from the group consisting of poly(N-vinylpyrrolidone), poly(4-vinylpyridine), poly(allyl amine), cellulose, cellulose acetate, dextran, poly(2-hydroxypropylmethacrylate), poly(acrylic acid), poly(ethylene glycol), poly(styrene sulfonic acid), poly(vinyl acetate), and polymethyl methacrylate. However, the polymer is not limited to the groups recited above

The term “target detecting material” refers to a material generating detectable signals by interactions with the target. In other words, the target detecting material is a material that may generate detectable signals when the target contacts or otherwise affects the fiber or is diffused into the fiber to interact with the fiber. The target detecting material may include a material generating a signal that is detectable by the interaction with the target that is selected from the group consisting of pH of a compound, a mixture, a solvent, a biological sample, a solution or mixture, temperature change of the fiber or ambient temperature change of the fiber, humidity change, pressure change, and solvent change.

The term “detectable signal” may include an optical signal or an electrical signal, but the “detectable signal” is not limited thereto. For example, the detectable signal may include a color change, change of fluorescence intensity, or change of electrical conductivity of the fiber.

The target detecting material may be fixed to the surface of the fiber or inside the fiber. When the target detecting material is fixed inside the fiber, reactions between moisture or oxygen in the air and the target detecting material may be retarded or prevented, thereby protecting the target detecting material and improving the stability thereof.

The target detecting material may be selected from the group consisting of a biological preparation, a chemical preparation, a physical preparation, and any mixture thereof. However, the target detecting material is not limited to the above identified groups.

The biological preparation may be a biological material that may generate a detectable signal by interactions with the target. The biological preparation may include an enzyme-specific substrate, an antibody, an aptamer, a peptide, a peptide nucleic acid (PNA), and a liposaccaride, but the biological preparation is not limited thereto.

The chemical preparation may be a chemical material that may generate a detectable signal by interactions with the target. The chemical preparation may include a pH indicator, a redox indicator, a metal-complex forming chelator, a diagnostic reagent, or a polydiacetylene-based polymer.

The chemical preparation may be selected from the group consisting of 3,3,5,5-tetramethylbenzidine (TMB), p-dimethylaminobenzaldehyde (DMAB), sodium nitroprusside (SNP), methyl red (MR), and sodium 2,6-dichlorophenolindophenol (SDI). However, the chemical preparation is not limited to the above identified groups.

TMB is a diagnostic reagent having a color changing from colorless to blue by the reaction with blood including hemoglobin having peroxidase and hydrogen peroxide. Nephritis, pyelonephritis, cystitis, urinary tumor, calculus of kidney and ureter, prostatitis, hemolytic disease, bleeding tendency, heart failure, and acute infection may be diagnosed using TMB when the blood content in urine is greater than a reference level.

DMAB is a diagnostic reagent having a color changing from colorless to pink by the reaction with urobilinogen. Dyshepatia, impairments of liver and biliary tract, stasis heart failure, fever, hemolytic anemia after exercise, anemia pernicious, and bleeding site may be diagnosed using DMAB when urobilinogen in urine is greater than a reference level.

SNP is a diagnostic reagent that undergoes a color change from colorless to pink by the reaction with acetoacetic acid that is a ketone. Diabetic acidosis, high-fat diets, low-carbohydrate diets, digestion/absorption disorders, fasting, frequent vomiting, and diarrhea may be diagnosed using DMAB when ketone in urine is greater than a reference level.

MR is a diagnostic reagent that undergoes a color change from red to various colors according to the pH level of a sample. MR turns to orange from red at pH 5, turns to yellow at pH 6, turns to green at pH 7, and turns to blue at pH 8. Diabetes, arthritis, fasting, hydropenia, and fever may be diagnosed using MR when the pH level of urine is acidic, and urinary tract infection, long-term administration of antacid agent, long-lasting hyperventilation, and frequent vomiting may be diagnosed using MR when the pH level of urine is alkaline. SDI is a diagnostic reagent undergoing a color change from cyan to yellowish green or yellow by the reaction with vitamin C. SDI may detect glucose or occult blood or resist reaction in a bilirubin test.

The “metal nanoparticle” may be a material causing a surface plasmon effect. For example, when the target influences the fiber or is diffused into the fiber, and thus the color of the target detecting material is changed by interactions with the fiber, the metal nanoparticle may amplify the color change by a surface plasmon effect. The metal nanoparticle may be a material having a high affinity to the polymer forming the matrix of the fiber or may form non-covalent bonds with the polymer. The metal nanoparticle may be fixed to the surface of the fiber or inside the fiber. The metal nanoparticle may be selected from the group consisting of gold (Au), silver (Ag), platinum (Pt), and mixtures thereof. Although the metal nanoparticle is described as being selected from a group consisting of gold (Au), silver (Ag), platinum (Pt), and mixtures thereof, the metal nanoparticle is not limited thereto and may include other metals or materials that may amplify the color change of the target detecting material. The metal nanoparticle may have a particle size of several tens to several hundreds nanometers (nm), for example, in the range of about 50 to about 500 nm.

The fiber may be hydrophobic, hydrophilic, or amphiphilic. For example, the fiber may be hydrophilic. The fiber may be soluble or insoluble in organic solvents or aqueous solvents. For example, the fiber may be insoluble in aqueous solvents. For example, the fiber may be hydrophilic and insoluble in aqueous solvents.

The fiber may have a macro-, micro-, or nano-sized diameter. Macrofibers may have a diameter in the range of about 600 to about 1000 μm, microfibers may have a diameter in the range of about 1 to about 500 μm, and may have a diameter in the range of about 1 to about 999 nm.

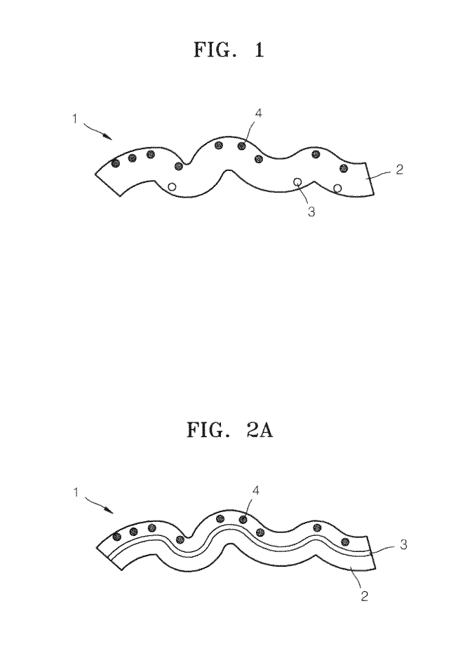

The fiber may be a simple fiber or may have a core-shell structure, but the fiber is not limited thereto. The simple fiber may have a structure in which target detecting materials and metal nanoparticles are arranged on the surface of the fiber or distributed in the fiber. The simple fiber may be prepared by spinning a fiber-forming composition using a single nozzle. FIG. 1 schematically shows an island-in-the-sea fiber 1 having a sea part including a polymer 2 and an island part including target detecting materials 3 and metal nanoparticles 4. The core-shell fiber has a double layered core-shell structure, in which the core includes the target detecting materials and the shell includes the polymer and the metal nanoparticles. The core-shell fiber may be prepared by electrospinning a fiber-forming composition using a double nozzle including an inner nozzle and an outer nozzle.

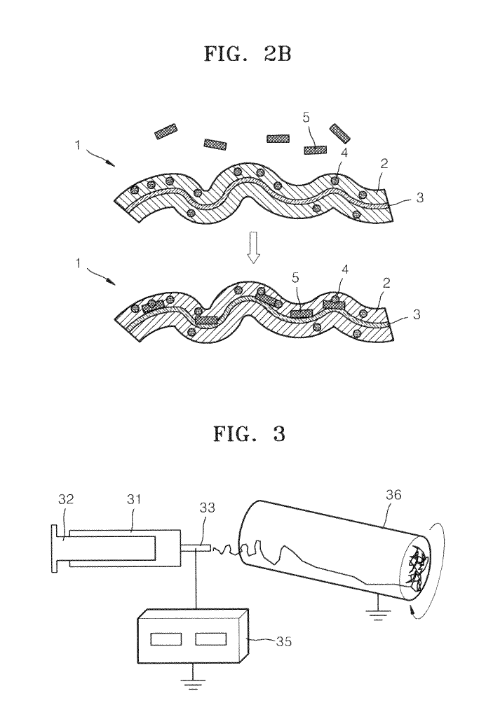

FIG. 2A schematically shows a core-shell fiber 1 that may have a double layer of a core including target detecting materials 3 and a shell including a polymer 2 and metal nanoparticles 4. In FIG. 2B, the core-shell fiber 1 and/or the target detecting materials 3 may change color when the target detecting materials 3 interact with the targets 5.

In accordance with example embodiments, a method of preparing a fiber may include preparing a composition including a polymer, a target detecting material, and a metal nanoparticle. In example embodiments the composition may be spun to prepare a fiber.

The polymer may be selected from the group consisting of poly(N-vinylpyrrolidone), poly(4-vinylpyridine), poly(allyl amine), cellulose, cellulose acetate, dextran, poly(2-hydroxypropylmethacrylate), poly(acrylic acid), poly(ethylene glycol), poly(styrene sulfonic acid), poly(vinyl acetate), and polymethyl methacrylate. However, the polymer is not limited to the above mentioned group.

The target detecting material may be selected from the group consisting of 3,3,5,5-tetramethylbenzidine (TMB), p-dimethylaminobenzaldehyde (DMAB), sodium nitroprusside (SNP), methyl red (MR), and sodium 2,6-dichlorophenolindophenol (SDI). However, the target detecting material is not limited to the above mentioned group.

The metal nanoparticle may be selected from the group consisting of gold (Au), silver (Ag), platinum (Pt), and mixtures thereof. The metal nanoparticle may be contained in the composition as a metal nanoparticle with zerovalent or a metal nanoparticle precursor compound that is prepared by oxidizing the metal nanoparticle. For example, the metal nanoparticle precursor compound may be HAuCl₄, AuOH, Au₂O, Au₂S, AuCl, Au(OH)₃, Au₂O₃, Au₂S₃, AuCl₃, AgNO₃, or H₂PtCl₆, but the metal nanoparticle precursor compound is not limited thereto. If the metal nanoparticle is a metal nanoparticle precursor compound, the method may further include reducing the fiber using a reducing agent (for example, Na(BH₃)CN or NaBH₄) after preparing the fiber.

The amount of the polymer contained in the composition may be in the range of about 5 to about 20 wt %.

The amount of the target detecting material contained in the composition may be in the range of about 0.5 to about 2 wt %.

The amount of the metal nanoparticles contained in the composition may be in the range of about 0.05 to about 0.20 wt %.

The composition may be prepared by dissolving the polymer, the target detecting material, and the metal nanoparticle in a solvent. The solvent may include an organic, aqueous solvent, and/or mixtures thereof. For example, the solvent may include water, methanol, ethanol, propanol, butanol, t-butyl alcohol, and isopropyl alcohol.

The composition may be maintained at room temperature for the formation of droplets in a nozzle and spinning.

The composition may further include a curing agent. The curing agent may bind to the polymer forming the fiber and may crosslink the polymer by a curing procedure using heat or UV rays. For example, the curing agent may be used when the polymer forming the fiber is soluble in aqueous solvents. For example, the curing agent may be glyoxal when the polymer forming the fiber is a polymer including a hydroxyl group, e.g., polyvinyl alcohol (PVA).

The composition may be spun to prepare the fiber. In particular, the composition may be spun using a spinning method (for example, electrospinning, wet spinning, conjugate spinning, melt blown spinning, and flash spinning) to prepare the fiber.

For example, FIG. 3 schematically shows an electrospinning device that may be used to prepare a fiber. In FIG. 3, a composition may fill an injector 31 and the composition may be pressed and discharged out of a nozzle 33 at a relatively constant rate using an injector pump 32. When a droplet of the composition is formed out of the nozzle 33, the composition may be spun by electrospinning to a collector 36 by applying a relatively high voltage in the range of about 10 to about 20 KV to the nozzle 33 using a power supply unit 35. The pumping rate of the injector 31, the diameter of the nozzle 33, the intensity of the voltage applied to the nozzle 33, the electrospinning rate, and the distance between the nozzle 33 and the collector 36 may vary according to physical properties of the fiber including a diameter range of the fiber.

The target detecting materials and the metal nanoparticles may be fixed to the surface of the fiber or inside the fiber.

Alternatively, a core-shell double layered fiber may be prepared using a double nozzle by electrospinning. That is, a core-shell fiber may include a core including the target detecting materials and the shell including the polymer and the metal nanoparticles. In example embodiments, the core-shell fiber may be prepared by spinning the target detecting materials via an inner nozzle and a composition including the polymer and the metal nanoparticles via an outer nozzle.

The method may further include curing the fiber prepared by electrospinning. A composition for preparing a fiber including a curing agent may be spun to prepare a fiber, and the polymer may be crosslinked by the curing agent during a curing process. The curing process may include heat-treatment or UV-treatment.

The method may further include reducing the fiber prepared by the electrospinning. If a fiber is prepared using a composition including the metal nanoparticle precursor compound, the fiber may be reduced using a reducing agent, for example, sodium cyanoborohydride (NaBH₃(CN)) or sodium borohydride (NaBH₄). The reducing of the fiber may be performed using any reducing agent that is commonly used in the art.

In accordance with example embodiments, a method of detecting a target in a sample may include contacting the fiber with a sample and observing detectable changes of the fiber before and after the contact. In example embodiments, the fiber may be contacted with the sample or arranged near the sample.

The sample may be a subject that is expected to include a target and may include a compound, a mixture, a biological material, and/or a solvent. Detectable changes of the fiber may be observed before and after contacting the fiber with the sample. By observing the detectable changes of the fiber, it may be identified whether the target exists in the sample. The detectable changes may include changes of optical or electrical characteristics of the fiber. For example, the changes of optical characteristics may include color change or change of fluorescence intensity of the fiber by irradiating infrared rays, UV rays, or visible rays to the fiber. Other changes may include changes in electrical characteristics of the fiber, for example, a change in the electrical conductivity of the fiber.

The existence of the target in the sample may be determined by comparing the colors of the fiber that is contacted with samples including the target with a fiber that is contacted with samples that do not include the target.

In example embodiments, the method may further include writing a calibration table using a fiber in which the target and the target detecting material interact with each other. The calibration table is a table showing the color change of the fiber according to the combination of the target detecting material and the target. The existence and concentration of the target in the sample may be detected by referring to the calibration table.

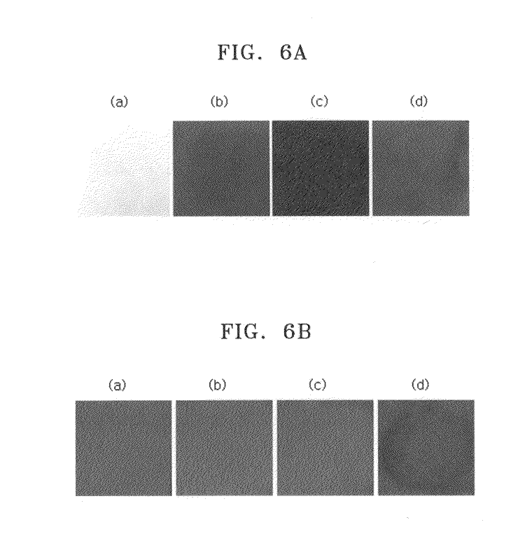

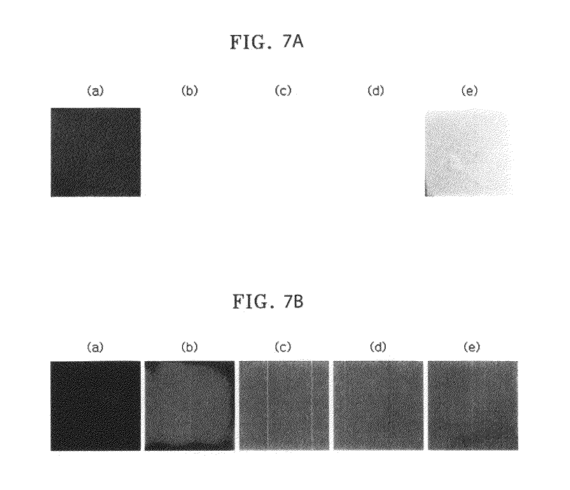

FIG. 5A shows color changes of MR according to the pH. FIG. 6A shows color changes of TMB according to the concentration of blood. FIG. 7A shows color changes of SDI according to the concentration of ascorbic acid.

The calibration table may include the color changes of the fiber as values based on CIE (Commission International d'Eclairage) xyY 1931 color space chromaticity diagram. For example, SDI that causes color changes by the reaction with ascorbic acid may provide Y, x, and y as shown in Table 1 below.

TABLE 1

| | Y | x | y |
|---|---|---|---|
| In the presence of | 15.8 | 0.2723 | 0.327 |
| ascorbic acid | | | |

For example, MR that causes color changes according to the pH level of solutions may provide x, y, and Y as shown in Table 2 below.

TABLE 2

| | Y | x | Y |
|---|---|---|---|
| Initial state | 37.9 | 0.4470 | 0.397 |
| pH 1.9 | 25.3 | 0.4553 | 0.350 |
| pH 3.4 | 25.6 | 0.4620 | 0.376 |
| pH 4.3 | 33.0 | 0.4483 | 0.373 |
| pH 5.6 | 33.5 | 0.4487 | 0.379 |
| pH 7.6 | 43.0 | 0.4150 | 0.387 |
| pH 8.9 | 49.2 | 0.3923 | 0.424 |
| pH 12.9 | 53.8 | 0.3873 | 0.451 |

Example embodiments provide a fiber complex including the fiber. The fiber complex may have a woven structure in which warp fibers and weft fibers cross each other. Alternatively, the fiber complex may have a non-woven structure prepared by aligning fibers in parallel lines or in random directions, binding the fiber with a synthetic resin adhesive, and pressing the fibers.

Example embodiments also provide for a kit including the fiber. The kit may include a structure having a relatively high mechanical strength obtained by aligning a bundle of fibers in a woven or non-woven form and press molding the fibers.

Example embodiments will be described in further detail with reference to the following examples. These examples are for illustrative purposes only and are not intended to be limiting.

### Example 1

0.5 g of cellulose acetate (7 wt % aqueous solution), 0.1 g of 3,3,5,5-tetramethylbenzidine (TMB) (10 wt %, toluene solution), and 0.005 g of Au were uniformly mixed while sonicating to prepare a composition for spinning. The composition was filled in an injector and discharged from a nozzle using an injector pump at a constant rate of 0.4 ml/h. When a droplet of the composition was formed out of the nozzle of the injector, the composition was spun to a collector by electrospinning by applying a voltage of 15 KV thereto using a power supply unit to prepare fibers having a diameter in the range of several tens to several hundreds of nanometers (nm).

### Example 2

0.5 g of polyvinyl alcohol (PVA, 7 wt % aqueous solution), 0.04 g of glyoxal (40 wt %, aqueous solution), 0.1 g of methyl red (MR, 10 wt %, toluene solution), and 0.005 g of Au were uniformly mixed while sonicating to prepare a composition for spinning. Fibers were prepared by electrospinning the composition in the same manner as in Example 1. The fibers were cured by heat-treatment at 120° C. for 1 hour.

### Example 3

0.5 g of polymethylmethacrylate (PMMA, 15 wt % aqueous solution), 0.1 g of 2,6-dichlorophenolindophenol (SDI, 10 wt %, toluene solution), and 0.4 g to 0.8 g of HAuCl₄ (0.06, 0.09, 0.12, and 0.19 wt %) were uniformly mixed during sonicating to prepare a composition for spinning. Fibers were prepared by electrospinning the composition in the same manner as in Example 1. The fibers were cured by heat-treatment at 120° C. for 1 hour.

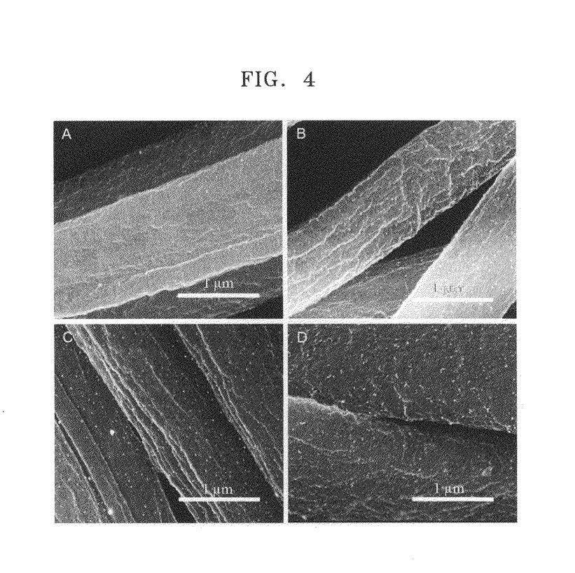

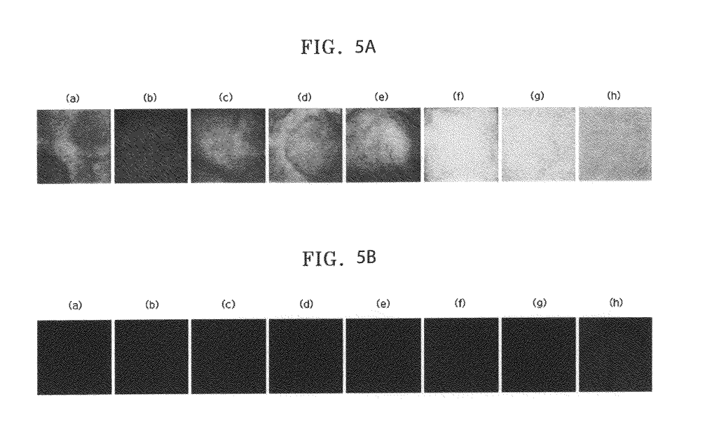

The fibers were processed in 100 mM NaBH₄ at 60° C. for 2 hours. FIGS. 4A to 4D are enlarged scanning electron microscope (SEM) images of fibers prepared as described above. Referring to the SEM images, metal nanoparticles are fixed to the surface of the fibers.

### Experimental Example 1

### (1.1) Preparation of Calibration Table 1

Compounds listed in Table 3 below were completely dissolved in 500 ml distilled water, 1M HCl was added thereto to set the pH level of the mixture to 6 to prepare artificial urine (Phillips, M J Butte and G M Whitesides, Angew. Chem. Int. Ed. 2007, 46, 1318-1320).

TABLE 3

| | CM (mM) | m (g) |
|---|---|---|
| Lactic acid | 1.1 | 0.058 |
| Citric acid | 2 | 0.192 |
| Sodium hydrogen carbonate | 25 | 1.05 |
| Urea | 170 | 5.105 |
| Calcium chloride | 2.5 | 0.144 |
| Sodium chloride | 90 | 2.629 |
| Magnesium sulfate | 2 | 0.12 |
| Sodium sulfate | 10 | 0.71 |
| Potassium dihydrogen phosphate | 7 | 0.476 |
| Potassium phosphate, dibasic | 7 | 0.609 |
| Ammonium chloride | 25 | 0.543 |

The artificial urine was dropped on the fiber prepared according to Example 2, and the color of the fiber was observed (reference). 1M HCl or 1M NaOH was added to the artificial urine to set the pH level to a range of about 1.9 to about 12.9. The artificial urine having the pH level was dropped on the fiber prepared according to Example 2, and the color of the fiber was observed. The results are shown in FIG. 5A. As shown in FIG. 5A, the color of the artificial urine drastically changed according to the pH.

For comparison, artificial urine having various pH levels was dropped on a filter paper platform (Advantec Toyo Kaisha Ltd.), and the color change was observed. The results are shown in FIG. 5B.

In FIGS. 5A and 5B, (a) shows the color of the sample not treated, and (b), (c), (d), (e), (f), (g), and (h) respectively have the pH levels of 1.9, 3.4, 4.3, 5.6, 7.6, 8.9, and 12.9.

### (1.2) Preparation of Calibration Table 2

0.001 ml(b), 0.0001 ml(c), and 0.00001 ml(d) of blood were respectively mixed with 100 ml of ethanol, and the solutions were dropped on the fiber prepared according to Example 1, and color changes were observed. The results are shown in FIG. 6A.

For comparison, 0.01 ml(b), 0.001 ml(c), and 0.0001 ml(d) of blood were respectively mixed with 100 ml of ethanol, and the solutions were dropped on the filter paper platform, and color changes were observed. The results are shown in FIG. 6B.

In FIGS. 6A and 6B, (a) shows the color of the sample not treated.

As shown in FIGS. 6A and 6B, the fiber according to example embodiments has a large specific surface area and high sensitivity to color change of the target detecting material by interaction with the target, and thus a wide range of concentrations of the target material may be detected.

### (1.3) Preparation of Calibration Table 3

0.1 ml(b), 0.05 ml(c), 0.001 ml(d), and 0.0005 ml(e) of ascorbic acid were respectively mixed with 100 ml of water, and the solutions were dropped on the fiber prepared according to Example 3, and color changes were observed. The results are shown in FIG. 7A.

For comparison, 1 ml(b), 0.5 ml(c), 0.01 ml(d), and 0.0005 ml(e) of ascorbic acid were respectively mixed with 100 ml of water, and the solutions were dropped on a filter paper platform, and color changes were observed. The results are shown in FIG. 7B.

In FIGS. 7A and 7B, (a) shows the color of the sample not treated.

As shown in FIGS. 7A and 7B, the fiber according to example embodiments has a large specific surface area and high sensitivity to color change of the target detecting material by interaction with the target, and thus a wide range of concentrations of the target material may be detected.

### Experimental Example 2

### Diagnosis of pH of Urine

1 ml of urine of a subject was diluted with 100 ml of distilled water. 1 ml of the diluted urine was dropped on the fiber prepared according to Example 2, and the color of the fiber was observed. As a result of comparison of the color with the color of the calibration table 1, it was diagnosed that the urine of the subject had a normal pH level of 5.6.

The existence and amount of a target in a sample may be detected using the fiber for detecting a target, the fiber complex and kit including the fiber, the method of preparing the fiber, and the method and kit for detecting a target in a sample according to example embodiments.

It should be understood that the example embodiments described therein should be considered in a descriptive sense only and not for purposes of limitation. Descriptions of features or aspects within example embodiments should typically be considered as available for other similar features or aspects in other embodiments.

What is claimed is:

1. A fiber comprising:
a polymer;
a target detecting material; and
a metal nanoparticle,
wherein the target detecting material and the metal nanoparticle are fixed to the polymer.

2. The fiber of claim 1, wherein the target detecting material and the metal nanoparticle are fixed to the polymer by non-covalent bonds.

3. The fiber of claim 1, wherein the target detecting material is fixed to one of a surface of the fiber and inside the fiber.

4. The fiber of claim 1, wherein the metal nanoparticle is fixed to one of a surface of the fiber and inside the fiber.

5. The fiber of claim 1, wherein the fiber includes a core and a shell surrounding the core, the core including the target detecting material and the shell including the polymer and the metal nanoparticle.

6. The fiber of claim 1, wherein the polymer is one of poly(N-vinylpyrrolidone), poly(4-vinylpyridine), poly(allyl amine), cellulose, cellulose acetate, dextran, poly(2-hydroxypropylmethacrylate), poly(acrylic acid), poly(ethylene glycol), poly(styrene sulfonic acid), poly(vinyl acetate), and polymethyl methacrylate.

7. The fiber of claim 1, wherein the target detecting material is configured to generate a detectable signal upon an interaction between the target detecting material and a target.

8. The fiber of claim 7, wherein the signal is one of an optical signal and an electrical signal.

9. The fiber of claim 1, wherein the target detecting material is configured to generate a signal that is detectable when the target detecting material interacts with a target that is one of pH of a compound, a mixture, a solvent, a biological sample, a solution or mixture, a temperature change of the fiber or ambient temperature change of the fiber, a humidity change, a pressure change, and a solvent change.

10. The fiber of claim 1, wherein the target detecting material is one of a pH indicator, a redox indicator, a metal-complex forming chelator, and an enzyme-specific substrate.

11. The fiber of claim 1, wherein the target detecting material is one of 3,3,5,5-tetramethylbenzidine (TMB), p-dimethylaminobenzaldehyde (DMAB), sodium nitroprusside (SNP), methyl red (MR), and sodium 2,6-dichlorophenolindophenol (SDI).

12. The fiber of claim 1, wherein the metal nanoparticle includes at least one of silver (Ag), gold (Au), and platinum (Pt).

13. A method of preparing a fiber, the method comprising:
preparing a composition that includes a polymer, a target detecting material, and a metal nanoparticle; and
spinning the composition to prepare the fiber.

14. The method of claim 13, wherein the target detecting material is formed to generate a detectable signal when the target detecting material interacts with a target.

15. The method of claim 13, wherein the target detecting material is formed to generate a signal that is detectable when the target detecting material interacts with a target that is one of a pH of a compound, a mixture, a solvent, a biological sample, a solution or mixture, a temperature change of the fiber or ambient temperature change of the fiber, a humidity change, a pressure change, and a solvent change.

16. The method of claim 13, wherein the target detecting material is one of 3,3,5,5-tetramethylbenzidine (TMB), p-dimethylaminobenzaldehyde (DMAB), sodium nitroprusside (SNP), methyl red (MR), and sodium 2,6-dichlorophenolindophenol (SDI).

17. The method of claim 13, wherein the metal nanoparticle includes at least one of silver (Ag), gold (Au), and platinum (Pt).

18. A method of detecting a target in a sample, the method comprising:
providing the fiber of claim 1;
contacting the fiber to a sample; and
observing changes of the fiber before and after the contact.

19. The method of claim 18, wherein the changes include changes of at least one of an optical characteristic of the fiber and an electrical characteristic of the fiber.

20. A fiber complex comprising:
a plurality of fibers according to claim 1, wherein the fiber complex is one of a woven structure with the plurality of fibers crossing each other and a non-woven structure with the plurality of fibers being both aligned and randomly oriented, the nonwoven structure including a synthetic resin adhesive to bind the plurality of fibers together.
